(19) United States
(12) Patent Application Publication
(10) Pub. No.: US 2001/0009419 A1
(43) Pub. Date: Jul. 26, 2001

(54) Image data displaying system, image drawing apparatus, image drawing method and image drawing program

(76) Inventors: Hidenori Ikeno, Tokyo (JP); Naoyasu Ikeda, Tokyo (JP); Hiroshi Tsuchi, Tokyo (JP); Takashi Nose, Tokyo (JP)

Correspondence Address: SUGHRUE, MION, ZINN, MACPEAK & SEAS, 2100 Pennsylvania Avenue, N. W., Washington, DC, 20037-3202, US

(21) Appl. No.: 09/768,315

(22) Filed: Jan. 25, 2001

(30) Foreign Application Priority Data
Jan. 26, 2000 (JP) 017070/2000

(51) Int. Cl. G06T 9/00

(52) U.S. Cl. 345/555

(57) ABSTRACT

An image data displaying system in which compressed image data is transmitted to an image displaying apparatus via an information transmission facility and is decompressed into an original image using an image decompressing section provided in the image displaying apparatus so as to display the original image. The image data displaying system includes image data for one screen received via said information transmission facility, said image data in a mixture of progressive driving parts and interlacing scanning parts in groups of n-pieces of lines.

### BACKGROUND OF THE INVENTION

1. Field of the Invention

The present invention relates to an image data displaying system, and more particularly to the image data displaying system for compressing an image and for transmitting the compressed image between an image drawing apparatus and an image displaying apparatus, and an image data displaying system, an image drawing apparatus, an image drawing method and an image drawing program used in the displaying system. The present application claims priority of Japanese Patent Application No. 2000-017070 filed on Jan. 26, 2000, which is hereby incorporated by reference.

2. Description of the Prior Art

In a computer system represented by a personal computer or a like, an image displaying apparatus such as a display is indispensable as aman/machine interface. In the computer system, a CRT (Cathode Ray Tube) display is generally used at present. Concerning resolution, 640×640 dots, VGA (Video Graphics Array) standard, has been used from early on, however, 1024×768 dots, XGA (extended Graphics Array) standard and 1280×1024 dots, SXGA (Super extended Graphics Array) standard are generally used at present.

In the computer system, an amplitude-modulated analog signal is transmitted between an image drawing apparatus and the image displaying apparatus as image data in many cases. As its reason, since an analog signal has been used as a signal for the CRT display for a long time, a common signal connector is usually provided for most personal computers at present.

FIG. 7 is a block diagram showing an image data flow in the personal computer used at present. Explanations will be given of the image data flow with reference to FIG. 7.

Image data 3 generated by a still camera or an image processing software and stored as electronic data is transmitted to a drawing controlling section 5 by a processing unit 4 and is represented as image data 8.

In the processing unit 4, there is a case in that various source images are developed in a same screen by a software for supporting a GUI (Graphical User Interface) system or a like. In this case, the image data 3 is transmitted to the drawing controlling section 5 while being mixed with various original images. The display controlling section 5 separates original image data transmitted from the processing unit 4 into light of three primarycolors, namely, RGB (Red, Green and Blue), separates the original image data into image data 8 and synchronous data 9 notifying an image display timing to an image displaying apparatus 2 and converts the original image data to a signal for laser scanning. Then, the display controlling section 5 transmits the original image data from the image drawing apparatus 1 to an image displaying apparatus 2 as image data 8 and synchronous data 9.

The image displaying apparatus 2 converts the image data 8 and the synchronous data 9 input to a display control circuit 6 into an image data format suitable to an image display device 7 and thereby executes display operation.

As described above, conventionally, the CRT display is mainly used as the image display device 7, however, an FPD (Flat Panel Display) such as an LCD (Liquid Crystal Display) is being used at present.

The FPD is compatible with digital signal as input signal, and therefore, when an analog interface used in the conventional CRT display is used, it is necessary to execute complicated processes, that is, it is necessary to once convert a digitized signal in the personal computer into analog signal and then to digitize the analog signal again in the LCD (for example, discussed in NIKKEI Byte, page 24, November, 1997).

Also, since the analog signal is apt to deteriorate during image signal transmission, problems of image deterioration occurs such as display blur, color blur and gradation aberration which are not seen in the LCD originally driven by a digital signal.

Further, concerning costs, a high speed and high resolution A/D converter is expensive.

Since the analog interface needs a section for processing analog signal and can not be integrated like a digital IC (Integrated Circuit), there is a problem in that costs increase.

A system for transmitting a digital signal without analogizing a signal between the image drawing apparatus 1 and the image displaying apparatus 2 is proposed in order to be suitable to a characteristic of the FPD compatible with the digital signal. For example, a LVDS (Low-Voltage Differential Signaling) system is proposed by National Semiconductor Corporation, U.S.A. and a TMDS (Transition-Minimized Differential Signaling) system is proposed by Silicon Image Corporation, U.S.A.

As a data transmission system, a semi-serial system is used in which the image data 8 is transmitted using a communication cable for transmitting plural digital image signals and the synchronous data 9 is transmitted using a pair of cables for transmitting clock signals.

In the above-mentioned systems, all data are transmitted without reducing a total amount of transmission data. Also, a data rate for transmitting an image is constant and there is no data variation caused by a difference of images.

As system software including a graphical interface such as Windows (registered by Microsoft Corp.) is generally used, and resolution of the screen increases. In other words, conventionally, the VGA (640×480 dots) standard is used, however, currently, the XGA (1024×768 dots) standard and the SXGA (1280×1024 dots) standard are mainly used at present.

Also, particularly, in a high edge area, an ultra fine display such as a QXGA (2048×1536 dots) standard and a QUXGA (3200×2400 dots) standard may be required in the future.

In the ultra fine display, a problem occurs when the image data 8 is transmitted from the image drawing apparatus 1 to the image displaying apparatus 2.

In other words, when the ultra fine display such as the QUXGA standard is executed, it becomes necessary to transmit image data 8 extremely larger than that of the XGA standard (approximately nine times) from the image drawing apparatus 1 to the image displaying apparatus 2. Therefore, transmission capacity is not enough in the data transmission system currently used.

As a countermeasure to a case in that the transmission capacity is not enough, if an amount of image data 8 transmitted from the image drawing apparatus 1 to the image displaying apparatus 2 can be reduced in any way, it becomes possible to transmit image data 8 using a narrow cable (small transmission capacity cable) from the image drawing apparatus 1 to the image displaying apparatus 2.

In order to reduce the amount of image data 8 to be transmitted, various systems are provided. In a well-known system, only parts of image data 8 different from parts of image data 8 in preceding one frame or preceding several frames are extracted among a frame data to be transmitted and only different image data is transmitted (SID (Society for Information Display) '99 DIGEST, page 118 preliminary papers or Japanese Patent Publication No. 2929105). However, in this system, when all of the image changes, it is necessary to transmit all of the image data 8 from the image drawing apparatus 1 to the image displaying apparatus 2. As a result, there is no effect of reducing the amount of image data 8 as image differential data.

Therefore, in this case, since the amount of image data 8 to be transmitted from the image drawing apparatus 1 to the image displaying apparatus 2 increases and exceeds a capacity of a transmission line for transmitting image data 8 from the image drawing apparatus 1 to the image displaying apparatus 2, number of frames is reduced though a writing speed of sixty frames per second is usually required, and thereby there is a problem in that dynamic image display becomes unnatural.

Also, in the system, it is necessary for the image displaying apparatus 2 to be provided with a memory (frame memory) capable of storing image data 8 for one screen at least, and therefore, costs increase.

Description of Related Art

To solve the above-described problems, the applicant of the present invention already provides an image data displaying system for compressing image data for one line and for transmitting compressed image data from an image drawing apparatus 1 (FIG. 7) to an image displaying apparatus 2 in Japanese Patent Application No. Hei 11-192744 (not laid open when the Japanese Patent Application, on which the present Application is based, was filed) . In the image data displaying system, an image is compressed for every line not for every frame, and thereby, a data transmission amount to be transmitted from the image drawing apparatus 1 to the image displaying apparatus 2 is reduced to 1/n of the data transmission amount from the image drawing apparatus 1 to the image displaying apparatus 2 in a non-compression case. At this time, when an amount of compressed data for one line exceeds 1/n of the data transmission amount, the line is not compressed and is transmitted using a time for transmitting n-pieces of lines, all data of n-pieces are transmitted using n-pieces of frames, and then a partial interacting (partial interacting drive: I drive) display is executed.

Using the image data displaying system, when an amount of compressed data of n-pieces of lines is larger than 1/n of an original data amount, a compressed result stored in a memory buffer is not output. Therefore, a capacity of the memory buffer may be keep only original data of one line and it is unnecessary to have a large buffer memory. As a result, it is possible to provide an image data displaying system for displaying an image of a large capacity at a low cost.

However, in the system discussed in Japanese Patent Application No. Hei 11-192744, various problems occur when a display device of a storing-display type such as a LCD (Liquid Crystal Display) is used.

There is a first problem which occurs also in a display device for executing a luminescent display of an impulse-type such as a CRT display. In the first problem, it is assumed that data of lines not transmitted during a transition from a progressive drive (P drive) to the partial interacting drive (I drive) in one frame is displayed by black or white. When black is displayed, parts of the I drive become darker than those of the P drive and when white is displayed, parts of the I drive become lighter than those of the P drive, and then though display is carried out, luminance of a whole screen becomes unbalanced in both cases.

Also, data of lines transmitted in the I drive are transmitted originally using all transmission time for n-pieces of lines, and therefore, when a first line among n-pieces of lines is displayed, all data to be displayed are transmitted after passing a time for displaying n-pieces of lines and are displayed after requiring a display by n-pieces of lines.

As a result, in parts for an I drive display, no display is executed at a time at which a display should be originally executed and a delay of a display time is generated. Therefore, a distorted display is displayed to a user and there is a possibility in that the user feels uncomfortable and becomes tired.

There is a second problem in that image quality deterioration such as an unequal display or a blur occurs and a life of the display also shortens, since, in a case in that the LCD is used as the display device in the system, direct current components remain at display pixel parts of the LCD caused by a driving system of parts in which image data is displayed by a partial interlacing system.

### SUMMARY OF THE INVENTION

In view of the above, it is an object of the present invention to provide an image data displaying system of partial interlacing data in which there is no change of luminance of an image and there is not a non-agreeable image display state when a signal output from an image drawing apparatus changes from a progressive drive to an interlacing drive and no direct current component remains in a case of using an LCD as a display device.

According to a first aspect of the present invention, there is provided an image data displaying system in which compressed image data is transmitted to an image displaying apparatus via an information transmission facility and is decompressed into an original image using an image decompressing section provided in the image displaying apparatus so as to display the original image, the image data displaying system including:

image data for one screen received via the information transmission facility, the image data in a mixture of progressive driving parts and interlacing scanning parts in groups of n-pieces of lines.

In the foregoing, a preferable mode is one wherein when an interlacing scanning is started at an m-th frame, the interlacing scanning is continued until an m+(n−1)th frame and one line is transmitted among the n-pieces of lines in a group for a frame during the interlacing scanning, and then n-pieces of data are transmitted using n-pieces of frames which start from an m-th frame.

Also, a preferable mode is one wherein an identifier is added to the compressed image data to be transmitted to the image displaying apparatus via the information transmission facility for each line to be transmitted, for each group including n-pieces of lines or for each frame, and the image displaying apparatus is capable of recognizing whether a progressive scanning state or an interlacing scanning state and image data of which a line is transmitted in a case of the interlacing scanning state.

Also, a preferable mode is one wherein the image displaying apparatus includes a line buffer of (n−1) pieces of lines and a controlling section, and when a time necessary for transmitting a line is set to i, a position of a line to be displayed is delayed by i×(n−1) at least and displayed from a position of the compressed image data via the information transmission facility.

Also, a preferable mode is one wherein when the interlacing scanning state exists in a screen and it is assumed that image data transmitted during the interlacing scanning state is an 1-th line among the n-pieces of lines, where the 1 is a natural number of 0 or more and (n−1) or less, data of the 1-th line is displayed for all lines of a group including n-pieces of lines in which the interlacing scanning is executed in the frame.

Also, a preferable mode is on wherein the image data displaying apparatus uses a storage type display such as an LCD or a plasma display, and when the interlacing scanning state exists in the screen and it is assumed that image data transmitted during the interlacing scanning state is an 1-th line among the n-pieces of lines, where the 1 is a natural number of 0 or more and (n−1) or less, only the 1-th line is scanned among a group including n-pieces of lines and other lines except for the 1-th line are not scanned and image data which is previously written is displayed as it is.

Also, a preferable mode is one wherein when the image data displaying apparatus uses a device requiring an alternating voltage drive as the image display device, a period continuing the interlacing scanning is set to 2n-pieces of frames in groups of n-pieces of lines, and thereby no remaining DC occurs.

Also, a preferable mode is one wherein the image data displaying apparatus includes a controlling section for controlling a display image based on an identifier added to each line forming an image.

Furthermore, a preferable mode is one wherein in the image data displaying apparatus, an identifier is added to each group of n-pieces of lines to be a unit for the interlacing scanning, an operation state is recognized and a number of frames is counted.

According to a second aspect of the present invention, there is provided an image data displaying system including:

an image drawing apparatus, and an image data displaying apparatus;

the image drawing apparatus including:

a converting section for receiving electronic image data to be displayed and for converting the electronic image data into image data of a bit string form;

a compressing section for compressing the image data into groups of plural lines such as n-pieces of lines of the image data which is compressed; and

a drawing controlling section, when a compressed result is below a predetermined rate of a data amount before compression, for outputting compressed image data as display data and for applying an identifier indicating the compressed image data to the display data, and when the compressed result is not below the predetermined rate of the data amount before compression, for selecting data of one line among n-pieces of lines, for outputting the data as display data and for applying an identifier indicating that a display block shifts to a partial interlacing drive and the display data is original data before compression or is data after compression to the display data to be output;

the image data displaying apparatus including:

a decompressing section for receiving the display data transmitted from the image drawing apparatus via a communication transmission facility and for decompressing the display data so as to output a decompressed result; and

an image displaying section;

a display controlling section for analyzing the display data, when the display data has the identifier showing compressed image data, for outputting decompressed display data of n-pieces of lines which is an output from the decompressing section to said image displaying section, when the display data has the identifier showing that the display data is a part of the partial interlacing drive, for receiving the display data of one line supplied from the decompressing section and displaying the display data on the image displaying section, and when the image displaying section executes display, for preventing an average luminance from decreasing by drawing all n-pieces of lines using data of one line among n-pieces of lines as image data for the interlacing drive in order to eliminate a luminance difference between a part displayed by a progressive drive and a part displayed by the partial interlacing drive.

In the foregoing, a preferable mode is one wherein the image data displaying apparatus includes a line buffer for holding image data decompressed by the decompressing section, in a case of the progressive drive, the image data is supplied to the image displaying section and displayed after a time delay of (n−1) pieces of lines, in a case of the partial interlacing drive, data of one line of compressed image data to be transmitted to the decompressing section is transmitted using a time requiring to transmit image data compressed for the progressive drive of n-pieces of lines, image data is transmitted from the line buffer to the image displaying section at a timing at which the one line is originally displayed.

Also, a preferable mode is one wherein the image data displaying apparatus includes a state storing section for storing whether a drive state of a line to be displayed on the image displaying section is the progressive drive or the partial interlacing drive.

According to a third aspect of the present invention, there is provided an image drawing apparatus including:

a converting section for receiving electronic image data to be displayed and for converting the electronic image data into an image data of a bit string form;

a compressing section for compressing the image data into groups of plural lines such as n-pieces of lines of the image data which is converted; and

a drawing controlling section, when a compressed result is below a predetermined rate of a data amount before compression, for outputting compressed image data as display data to an image drawing apparatus and for applying an identifier indicating the compressed image data to the display data, and when the compressed result is not below the predetermined rate of the data amount before compression, for selecting data of one line among n-pieces of lines, for outputting the data as display data to the image drawing apparatus and for applying an identifier indicating that a display block shifts to a partial interlacing drive and the display data is original data before compression or is data after compression to the display data to be output.

According to a fourth aspect of the present invention, there is provided an image data displaying apparatus including:

a decompressing section for receiving display data which is compressed into groups of plural lines such as n-pieces, when a compressed result is below a predetermined rate of a data amount before compression, for applying an identifier indicating the compressed image data to the display data, and when the compressed result is not below the predetermined rate of the data amount before compression, for selecting data of one line among n-pieces of lines, for outputting the data as display data, for applying an identifier indicating that a display block shifts to a partial interlacing drive and the display data is original data before compression or is data after compression to the display data and for decompressing the display data and outputting a decompressed result; and

a display controlling section for analyzing the display data, when the display data has the identifier showing compressed data, for outputting decompressed display data of n-pieces of lines which is an output from the decompressing section to an image displaying section, when the display data has the identifier indicating that the display data is a part of the partial interlacing drive, for receiving display data of one line supplied from the decompressing section and displaying the display data on the image displaying section, and when the image displaying section executes display, for preventing average luminance from decreasing by drawing all n-pieces of lines using data of one line among n-pieces of lines as image data for the partial interlacing drive in order to eliminate a luminance difference between a part displayed by a progressive drive and a part displayed by the partial interlacing drive.

In the foregoing, a preferable mode is one further including:

a line buffer for holding image data decompressed by the decompressing section:

wherein in a case of the progressive drive, the image data is supplied to the image displaying section and displayed after a time delay of (n−1) pieces of lines, in a case of the partial interlacing drive, data of one line of compressed image data to be transmitted to the decompressing section is transmitted using a time requiring to transmit image data compressed for the progressive drive of n-pieces of lines, image data is transmitted from the line buffer to the image displaying section at a timing at which the one line is originally displayed.

Also, a preferable mode is one further including:

a state storing section for storing whether a drive state of a line to be displayed on the image displaying section is the progressive drive or the partial interlacing drive.

Furthermore, preferable mode is one wherein in a case of interlacing scanning to the image displaying section, a line buffer of (n−1) pieces of lines corresponding to a number n of lines in a group is provided in order to eliminate a display delay by delaying a time in the image displaying section by a time for displaying (n−1) pieces of lines and concerning a block which shifts to an interlacing scanning state once, interlacing scanning is executed continuously during 2n-pieces of frames corresponding to the number n of lines in the group at least in order to set an average voltage in pixel portions in the image displaying section to zero.

According to a fifth aspect of the present invention, there is provided an image drawing method including:

a step of receiving electronic image data to be displayed and of converting the electronic image data into image data of a bit string form;

a step of compressing the image data into groups of plural lines such as n-pieces of lines of the image data which is converted; and

a step, when a compressed result is below a predetermined rate of a data amount before compression, for outputting compressed image data as display data to an image drawing apparatus and for applying an identifier indicating the compressed image data to the display data, and when the compressed result is not below the predetermined rate of the data amount before compression, of selecting data of one line among n-pieces of lines, of outputting the data as display data to the image drawing apparatus and applying an identifier indicating that a display block shifts to a partial interlacing drive and the display data is original data before compression or is data after compression to the display data to be output.

According to a sixth aspect of the present invention, there is provided an image drawing program for causing a computer to carry an image drawing method, the image drawing method including:

a step of receiving electronic image data to be displayed and of converting the electronic image data into image data of a bit string form;

a step of compressing the image data into groups of plural lines such as n-pieces of lines of the image data which is converted; and

a step, when a compressed result is below a predetermined rate of a data amount before compression, for outputting compressed image data as display data to an image drawing apparatus and for applying an identifier indicating the compressed image data to the display data, and when the compressed result is not below the predetermined rate of the data amount before compression, of selecting data of one line among n-pieces of lines, of outputting the data as display data to the image drawing apparatus and applying an identifier indicating that a display block shifts to a partial interlacing drive and the display data is original data before compression or is data after compression to the display data to be output.

With the above configurations, it is possible to reduce a data transmission amount transmitted from an image drawing apparatus to an image data displaying apparatus to 1/n of that in a conventional system, where n is a natural number of 2 or more.

Now, when n is large, a possibility increases in that a response in re-writing screen decreases. However, a suitable number is selected as n, and thereby it is possible to control the data transmission amount to a low level while a display quality (video quality) can be kept high.

Also, the display data is compressed not per frame but plural lines, and therefore, an expensive frame memory is not necessary in the image data displaying apparatus and it is possible to produce the image data displaying apparatus at low cost.

Further, the image data displaying apparatus holds a luminance uniformity of a whole screen without distorted display.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing a configuration of an image data displaying system according to a first embodiment of the present invention;

FIG. 2 is a block diagram showing a configuration of an image data displaying system according to a third embodiment of the present invention;

FIG. 3A and FIG. 3B are tables explaining an operation of the image data displaying system of the third embodiment;

FIG. 4 is a block diagram showing a configuration of an image data displaying system according to a fourth embodiment of the present invention;

FIG. 5A and FIG. 5B are tables explaining an operation of the image data displaying system of the fourth embodiment;

FIG. 6 is a block diagram showing a configuration of an image data displaying system according to a fifth embodiment of the present invention; and

FIG. 7 is a block diagram showing a configuration of a conventional image data displaying system.

### DETAILED DESCRIPTION OF THE PREFERRED EMBODIMENTS

Best modes for carrying out the present invention will be described in further detail using various embodiments with reference to the accompanying drawings.

### Outline

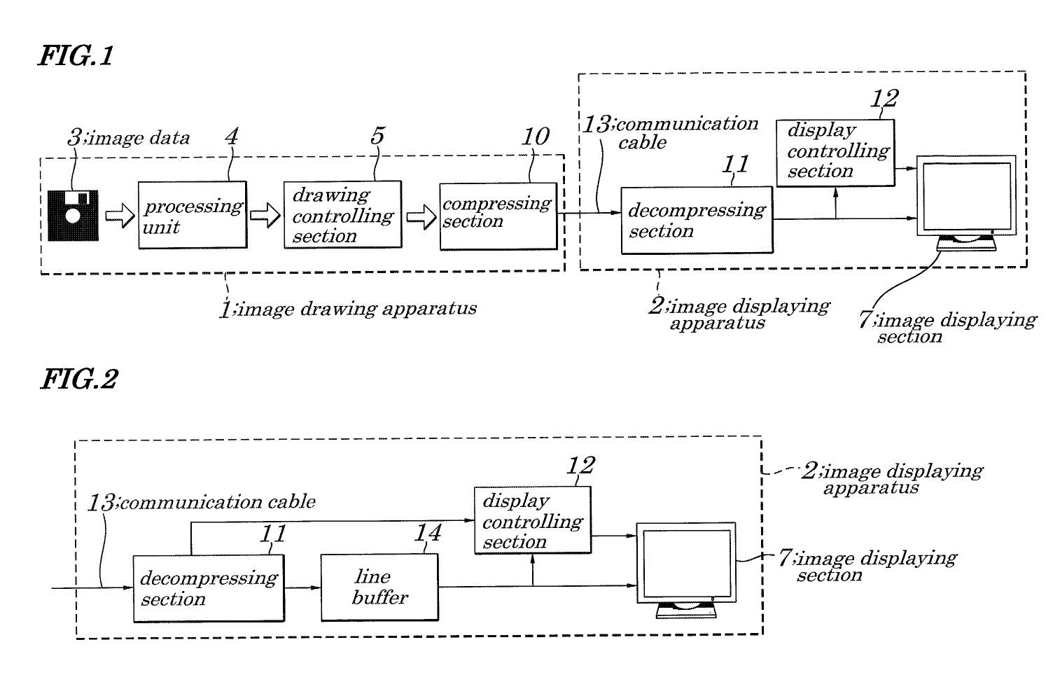

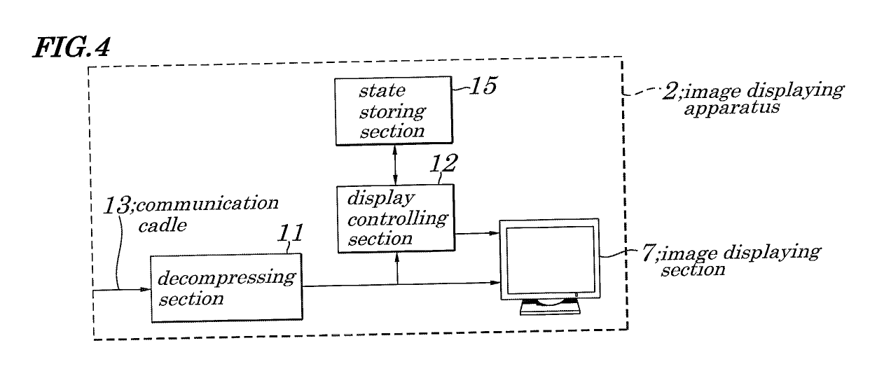

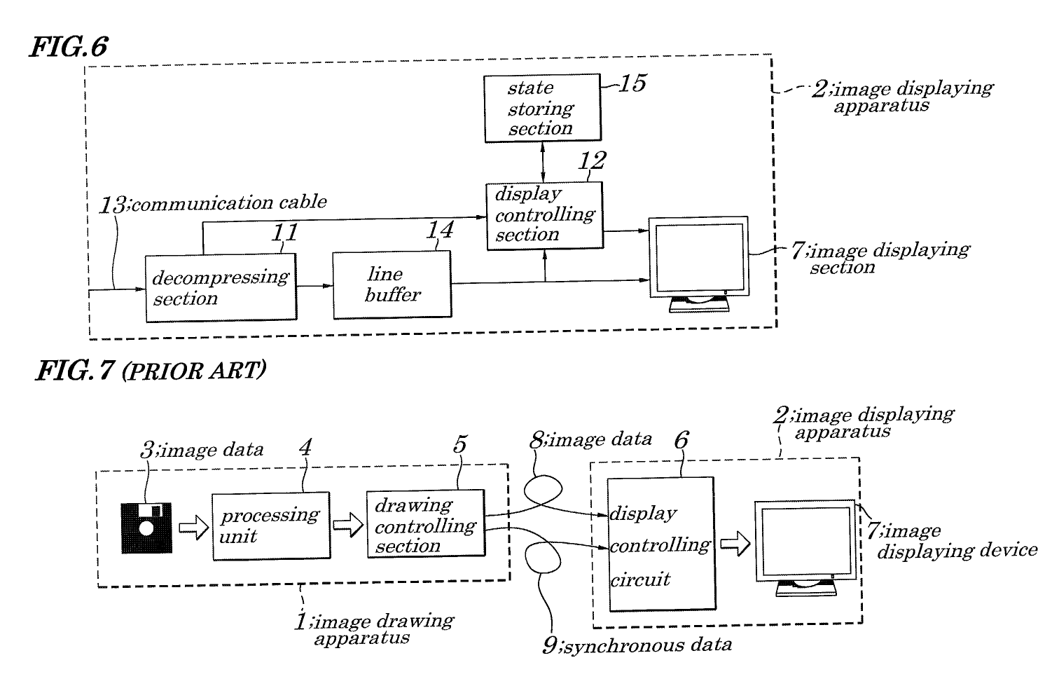

First, explanations will be given of an outline of the present invention. In an image data displaying system of the present invention, when a line capacity between an image drawing apparatus 1 (FIG. 1) and an image data displaying apparatus 2 (FIG. 1, FIG. 2, FIG. 4 or FIG. 6) is below a line capacity calculated from image data amount required for no-compression at least, in order to decrease the image data amount transmitted from the image drawing apparatus 1 to the image data displaying apparatus 2, the image drawing apparatus 1 compresses image information and transmits it to each line forming an image, and when a required line capacity calculated from the image data amount after compression exceeds the line capacity between the image drawing apparatus 1 and the image data displaying apparatus 2, n-pieces of lines are formed into a group and lines are transmitted one by one in one frame to the image displaying apparatus 2 without compressing information belonging to the group.

With this configuration, a partial interlacing drive for transmitting all the image data can be executed without decreasing a frame rate.

Also, tag information showing which operation technique is used for each line, for each block including n-pieces of lines or for each frame is added to image data transmitted from the image drawing apparatus 1, and then the image data is transmitted to the image data displaying apparatus 2 via a communication cable 13 (FIG. 1, FIG. 2, FIG. 4 or FIG. 6).

The image data displaying apparatus 2 analyzes the tag information (identification information) of the image data transmitted from the image drawing apparatus 1 via the communication cable 13. In a case of the partial interlacing drive, a line among n-pieces of lines which are transmitted is substituted for the n-pieces of lines in a group.

The image data displaying apparatus 2 analyzes the tag information of the image data transmitted from the image drawing apparatus 1 via the communication cable 13. In a case of the partial interlacing drive, no data is written in other lines among the n-pieces of lines which are transmitted except for the line which is displayed and then image data which is previously written is continuously displayed.

Also, when a partial interlacing drive technique is used, in order to eliminate a discrepancy of a display time between a progressive drive and a partial interlacing drive, the image data displaying apparatus 2 is provided with a line buffer 14 (FIG. 2 or FIG. 6) for (n−1) pieces of lines and delays a display time for (n−1) pieces of lines than the transmitted image data at least.

When as an image displaying section 7 (FIG. 1, FIG. 2, FIG. 4 or FIG. 6) in the image data displaying apparatus 2, an image display device for driving using an alternating voltage such as an LCD is used, in order to eliminate direct current components generating at liquid crystal pixel parts in a case of the partial interlacing drive technique, concerning a group of n-pieces of lines which shifts to the partial interlacing drive, the partial interlacing drive is kept during 2n-pieces of frames.

According to the present invention, it is possible to reduce the image data transmission amount transmitted from the image drawing apparatus 1 to the image data displaying apparatus 2 to 1/n of transmission amount of image data 8 (FIG. 7) in the conventional system, where n is a natural number of 2 or more.

Now, when n is large, a possibility increases in that a response in re-writing screen decreases. However, a suitable number is selected as n, and thereby it is possible to control the image data transmission amount to a low level while a display quality (video quality) can be kept high.

Also, the image data is compressed not for each frame but for plural lines, and therefore, an expensive frame memory is not necessary in the image data displaying apparatus 2 and it is possible to produce an image displaying apparatus 2 at low cost.

Further, the image displaying apparatus 2 holds a luminance uniformity of a whole screen without distorted display.

### First Embodiment

FIG. 1 is a block diagram showing a configuration of an image data displaying system according to a first embodiment of the present invention.

The image data displaying system is provided with an image drawing apparatus 1 and an image displaying apparatus 2. The image drawing apparatus 1 is connected with the image displaying apparatus 2 via a communication cable 13.

The image drawing apparatus 1 is provided with a processing unit 4, a display controlling section 5 and a compressing section 10.

The image displaying apparatus 2 is provided with a decompressing section 11, a display controlling section 12 and an image displaying section 7.

In the image drawing apparatus 1, the processing unit 4 and the display controlling section 5 convert image data 3 originally displayed into image data of a bit string format. The image data which is converted into the bit string format is input into the compressing section 10. The compressing section 10 is provided with a buffer memory (not shown) for compressing image data into groups of n-pieces of lines and a compression engine (not shown) for actually compressing data.

The compressing section 10 compresses contents in a buffer frame (not shown) in the processing unit 4, namely, the image data input via the display controlling section 5 in units of n-pieces of lines and temporarily stores compressed image data (contents) in the buffer memory (not shown) in the compressing section 10. Any compression technique is available for compression in the compressing section 10.

The display controlling section 5 outputs the compressed image data stored in the compressing section 10 into the communication cable 13 as display data (not shown) when an amount of the compressed image data by the compressing section 10 is below 1/n of an amount of the image data before compressing.

An identifier (not shown) indicating a compression result is added to the compressed image data to be output to the communication cable 13.

Any position is available for a position of the identifier added to the compressed data to be output to the communication cable 13, for example, the identifier may be added to each line, an identifier may be added to each block including n-pieces of lines and an identifier may be added to each frame, as long as the image displaying apparatus 2 can recognize the identifier.

The display controlling section 5 selects data of one line among data of n-pieces of lines, the selected data corresponding to compressed data, and outputs it as display data when an amount of the compressed image data by the compressing section 10 is not below 1/n of an amount of the image data before compressing.

In this case, data of one line to be output may be non-compressed data before compression or compressed data after compression.

A block of the display data to be output to the communication cable 13 is shifted to the partial interlacing drive (I drive) and an identifier showing original data before compression (or showing compressed data) is given to the block.

It is possible to change which line is selected from a line string in blocks of n-pieces of lines per a frame.

In detail, for example, when a first line is selected from n-pieces of lines in a first frame, a second line is selected in a second frame, a third line is selected in a third frame, and a (n−1)th line is selected in a (n−1)th frame.

In the next frame, a compression rate is measured and a routine is continued again.

In this explanation, when a line is selected from the block including n-pieces of lines, in a selecting order, a number sequentially increases as 1, 2, 3 . . . n one by one. However, the present invention is not limited to this and the number may be decreased one by one or may be random.

The decompressing section 11 in the image displaying apparatus 2 decompresses the compressed image data transmitted from the image drawing apparatus 1 via the communication cable 13 and outputs a decompressed result.

The display controlling section 12 analyzes the image data transmitted from the image drawing apparatus 1 via the communication cable 13, and when the image data includes the identifier showing that the image data is compressed, outputs decompressed data of n-pieces of lines, namely, an output from the decompressing section 11, to the image displaying section 7 and controls the image displaying section 7 so as to execute a progressive drive (P drive).

Also, when the image data includes an identifier showing the I drive, the display controlling section 12 receives the image data of one line supplied from the decompressing section 11 and supplies the image data to be displayed by the image displaying section 7.

When the image displaying section 7 displays an image, the display controlling section 12, in order to eliminate a luminance difference between parts displayed by the P drive and parts displayed by the I drive, draws all n-pieces of lines using data of one line among n-pieces of lines transmitted as data of the I drive, and thereby prevents an average luminance from decreasing.

In this case, concerning that input image data is displayed on which line among n-pieces of lines in a block, a different line is selected for each frame. As selection techniques, a same rule defined in the image drawing apparatus 1 is used, or information indicating that input display data is displayed on which line is added to image information added to the compressed image data to be transmitted to the communication cable 13 from the image drawing apparatus 1, and thereby the input image data can be displayed without a problem.

In the first embodiment, explanations are given of a case in that the image drawing apparatus 1 and the image displaying apparatus 2 are separated, however, the image drawing apparatus 1 and the image displaying apparatus 2 may be formed in a same cabinet, may be formed on a same substrate or may be formed on a same chip and the communication cable 13 may be a chip internal wiring.

### Second Embodiment

Next, a second embodiment according to the present invention will be described. The second embodiment of the present invention improves a phenomenon in that concerning luminance of all the screen, only average luminance of parts of an I drive become dark because the number of scanning lines in the parts of the I drive is smaller than that of a P drive when the P drive and the I drive are mixed.

In the second embodiment, as an image displaying section 7 shown FIG. 1, a storage-type display element such as a liquid crystal display (LCD) or a plasma display is used. In this case, the image displaying section 7 formed from the storage-type display element such as the LCD or the plasma display is regarded as an image buffer, and concerning lines which are not scanned in a frame, data which is already written is not updated.

Therefore, an image displaying section 12 controls so that display data of one line supplied from a decompressing section 11 is displayed at a position defined by supplied data and other lines are not scanned, and thereby it is possible to eliminate the luminance difference between the parts of the P drive and the parts of the I drive.

### Third Embodiment

Next, a third embodiment according to the present invention will be described. FIG. 2 is a schematic block diagram showing a configuration of the third embodiment of the present invention. In the third embodiment, an image displaying apparatus 2 is provided with a line buffer 14 of (n−1) pieces of lines or more when a number of lines grouped during image data compression in the image drawing apparatus 1 (FIG. 19 is “n”. In FIG. 2, the line buffer 14 is positioned at a rear step of a decompressing section 11 and an output of the line buffer 14 is supplied to an image displaying section 7 and a display controlling section 12. The line buffer 14 delays a position of a line displayed in the image displaying section 7 for a time of (n−1) pieces of lines or more from a line of data actually transmitted via a communication cable 13. The line buffer 14 may be provided at any position between the decompressing section 11 and the image displaying section 7.

Compressed image data transmitted from the image drawing apparatus 1 to the image displaying apparatus 2 via the communication cable 13 is decompressed into image data before compression in the decompressing section 11. Information added to the compressed image data concerning a state of display data is transmitted from the decompressing section 11 to the display controlling section 12 and is used for display control.

Image data decompressed in the decompressing section 11 is input into the line buffer 14 and in a case of a P drive, the image data is delayed for (n−1) pieces of lines and then is read from the display controlling section 12 and is supplied to the image displaying section 7 so as to be displayed.

Also, in a case of an I drive, concerning the compressed image data to be transmitted to the decompressing section 11 via the communication cable 13, data of one line is transmitted using a time necessary to transmit image data of n-pieces of lines, the image data compressed during the P drive. The image data can be transmitted from the line buffer 14 to the image displaying section 7 at a timing at which the one line is originally displayed.

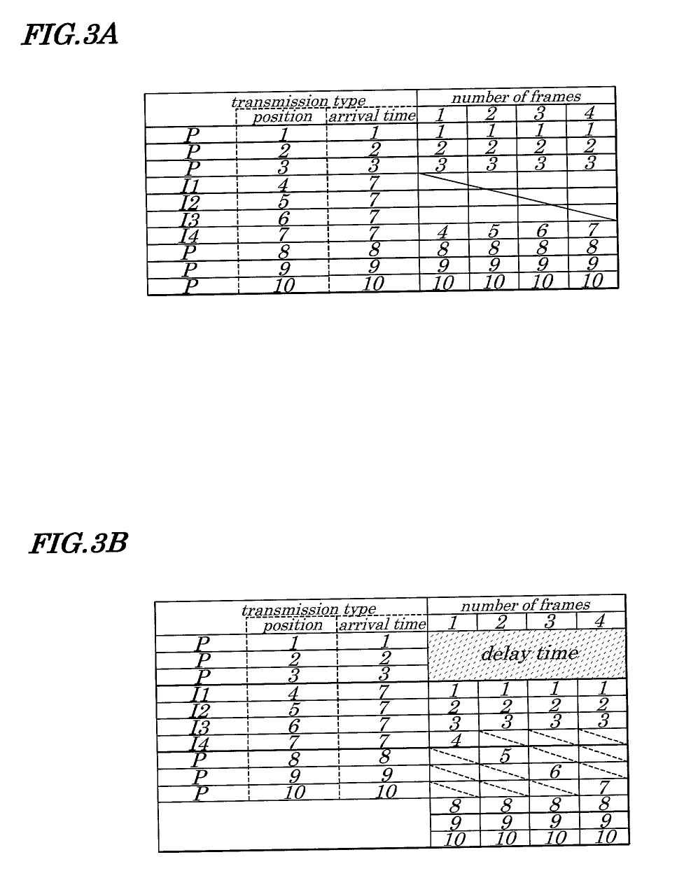

FIG. 3A and FIG. 3B are tables explaining a drive (I drive and P drive) in the third embodiment and showing that each line forming a screen is scanned by what scanning technique in accordance with a number of frames (time). Hereinafter, it is assumed that a number “n” of lines in a group is four and explanations will be given.

FIG. 3A shows a case in that there is no buffer memory (no line buffer) . In this case, in parts of the P drive (lines of which transmission type columns are defined as P), regardless of positions of lines to be transmitted, concerning an arrival time of a line arrived at the image displaying apparatus 2, positions of assumed transmission lines (called “position” in FIG. 3A) are coincide with positions calculated from a time at which an image must be originally displayed when image data arrives at the image displaying apparatus 2 (called “arrival time” in FIG. 3A) However, in parts of the I drive (parts of “I1” to “I4” in the transmission type column), though a line at a position at which an assumed transmission line position is fourth is transmitted in a first frame, a time received by the image displaying apparatus 2 is a time for writing a seventh line not a time for writing a fourth line.

Frames advance in this way, and in a second frame, a fifth line is written at a time at which a seventh line must be originally written, in a third frame, a sixth line is written at a time at which a seventh line must be originally written, and in a fourth frame, a seventh line is first written at a predetermined position (time) at which a seventh line must be originally written.

As described above, in this case of no buffer memory (line buffer), drive type is changed into the I drive, just then data is written at a timing shifting from a timing at which data must be originally written and a discrepancy occurs.

However, there is the line buffer 14 in the image displaying apparatus 2, and therefore, there is a delay of display time for (n−1) pieces of lines. As shown in FIG. 3B, even if all lines output by the I drive on an assumption that the lines are written in fourth line to seventh line arrive at the image displaying apparatus 2 at a time for writing the seventh line, the image can be displayed at an assumed time, in assumed order and at an assumed position caused by a display delay of the line buffer 14.

### Fourth Embodiment

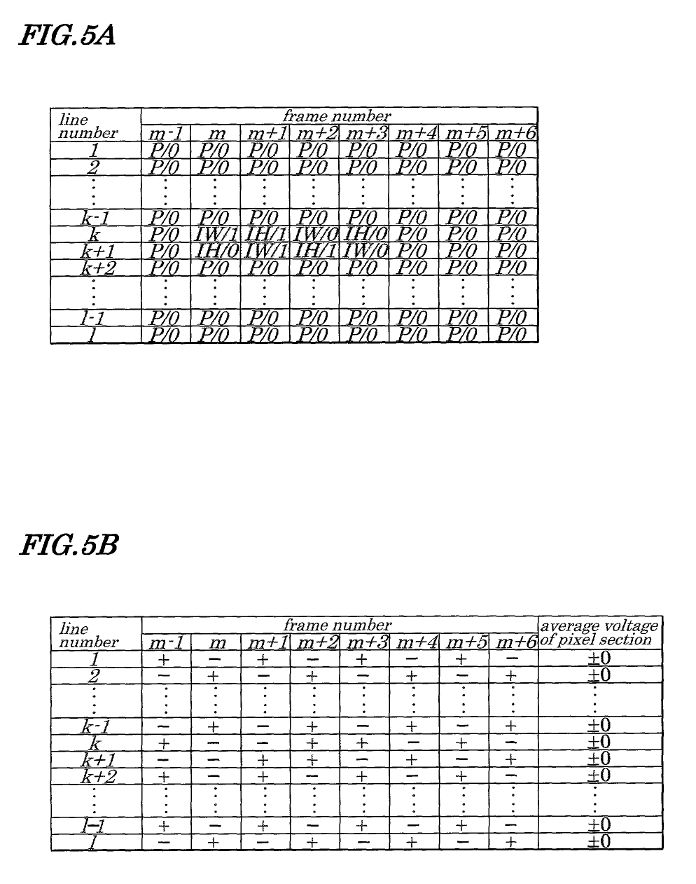

Next, a fourth embodiment according to the present invention will be described. FIG. 4 is a block diagram showing a configuration of the fourth embodiment. FIG. 5A and FIG. 5B are tables explaining the fourth embodiment. The fourth embodiment is effective for an image displaying section 7 using an image display device required for driving in an alternating electric field such as a liquid crystal display.

As shown in FIG. 4, an image displaying apparatus 2 according to the fourth embodiment is provided with a state storing section 15 for storing that a driving state of a line displayed by the image displaying section 7 is a P drive or an I drive.

For example, concerning one line of an image displayed on the image displaying section 7, in a case in that one bit is allocated in the state storing section 15 (it is assumed that initial state is the P drive and a corresponding bit is “0”), when a compression rate is low in a line k in an image drawing apparatus 1 (FIG. 1) and the drive state shifts from the P drive state to the I drive state, a bit corresponding to the line k provided in the state storing section 15 is changed from “0” to “1”.

Since a number n of lines forming a block for the I drive is previously known, the I drive starting at the line k is finished once at a line k+(n−1) . At this time, in a memory (not shown) in the state storing section 15, since all bits corresponding to line k to line k+(n−1) are “1”, it is understood that line k to line k+(n−1) are driven by the I drive concerning the previous drive.

When a block including line k to line k+(n−1) is driven by the I drive in a following frame, a corresponding bit in the state storing section 15 is inverted to “0” at a same time of drawing the line k and a bit corresponding to the line (k+1) in the state storing section 15 is inverted in a following frame.

In this way, the operation is continued to the line k+(n−1), and when description of the line k+(n−1) is finished, all bits corresponding to line k to line k+(n−1) forming the block are “0” and one period of the I drive state is finished.

Also, at a point of time at which all bits corresponding to line k to line k+(n−1) provided in the state storing section 15 becomes “1”, when the drive type of the image signal transmitted from the image drawing apparatus 1 becomes the P drive, a display controlling section 12 refers to memory bits of the state storing section 15 corresponding to the display lines. When the corresponding bits are “1”, in spite of that drawing type of the image data transmitted from the image drawing apparatus 1 is the P drive, the image displaying apparatus 2 assumes the I drive and executes the I drive.

With this drive, the block shifting to the I drive at once can continuously execute the I drive during 2n-pieces of frames. FIG. 5A shows this drive situation for each frame. FIG. 5A shows an example in that a number of lines of the display image is one and n=2.

As shown in FIG. 5A, in a case of that a frame number is m, a compression rate of the block including the line k and the line (k+1) is low, and the drive type is changed to the I drive though the P drive is executed until a line (k−1).

Therefore, in an m-th frame, writing in the I drive state is executed for the line k (IW) and the line (k+1) holds the image data which is written by a (m−1)th frame (IH).

In a following (m+1)th frame, the line k holds the image data written in the m-th frame as it is (IH) and new image data is written in the line (k+1) (IW). At this time, a bit corresponding to the line k of the state storing section 15 holds “0” in a case of the P drive, and when the drive type is changed to the I drive in the m-th frame and writing is executed, the bit is inverted and holds “1”.

Also, a bit corresponding to the line (k+1) is inverted in the (m+1)th frame and becomes “1”. A bit corresponding to the line k is inverted again in the (m+2)th frame and becomes “0”. A bit corresponding to the line (k+1) is inverted in the (m+3)th frame and becomes “0”.

In this way, the I drive is continued during four frames (=2n frames).

Also, concerning a voltage applied to the image displaying section 7, as shown in FIG. 5B, in the m-th frame, since a drive voltage is applied to the line k, a voltage direction is inverted from plus to minus, however, since no drive voltage is applied to the line (k+1), minus which is applied to the (m−n 1)th frame is kept.

In the following (m+1)th frame, no drive voltage is applied to the line k and minus is kept, however, the line (k+1) is driven and becomes plus.

In the (m+2)th frame, the line k changes to plus and the line (k+1) keeps plus. In the (m+3)th frame, the line k keeps plus and the line (k+1) inverts and becomes minus.

As shown in FIG. 5B, an average voltage of pixel portions becomes “0”. Since the I drive and the P drive are mixed, the average voltage of the pixel portions does not incline toward plus or minus and no remaining DC (Direct Current) occurs, and therefore, it is possible to form the image displaying section 7 having little deterioration and a high reliability.

In addition, in FIG. 4, the state storing section 15 is connected to the display controlling section 12, however, the present invention is not limited to this, the state storing section 15 may be positioned between a decompressing section 11 and the image displaying section 7 or may be positioned in any block making up the image drawing apparatus 1 and a signal output from the image drawing apparatus 1 is output as an I drive signal during 2n-pieces of frames.

Also, in the fourth embodiment, one bit is allocated for one line forming an image displayed on the image displaying section 7 for explanations, however, further large bits may be allocated instead of one bit, and a state may be stored per a further large block (unit) such as a block and a frame instead of a line.

Furthermore, in the fourth embodiment, the initial value of the memory bit provided in the state storing section 15 is “0”, however, the initial value maybe set to “1” and a transition state may be set inversely.

### Fifth Embodiment

Next, a fifth embodiment according to the present invention will be described. FIG. 6 is a block diagram showing a configuration of an image data displaying system according to the fifth embodiment. An image displaying apparatus 2 is provided with a decompressing section 11, a communication cable 13, a line buffer 14, a display controlling section 12, a state storing section 15 and an image displaying section 7.

The fifth embodiment has a configuration obtained by combining configurations of the first embodiment to the fourth embodiment. The line buffer 14 is similar that of the third embodiment and the state storing section 15 is similar to that of the fourth embodiment.

It is apparent that the present invention is not limited to the above embodiments but may be changed and modified without departing from the scope and spirit of the invention.

What is claimed is:

1. An image data displaying system in which compressed image data is transmitted to an image displaying apparatus via an information transmission facility and is decompressed into an original image using an image decompressing section provided in said image displaying apparatus so as to display said original image, said image data displaying system comprising:
image data for one screen received via said information transmission facility, said image data in a mixture of progressive driving parts and interlacing scanning parts in groups of n-pieces of lines.

2. The image data displaying system according to claim 1, wherein when an interlacing scanning is started at an m-th frame, said interlacing scanning is continued until an m+(n−1)th frame and one line is transmitted among said n-pieces of lines in a group for a frame during said interlacing scanning, and then n-pieces of data are transmitted using n-pieces of frames which start from an m-th frame.

3. The image data displaying system according to either claim 1, wherein an identifier is added to said compressed image data to be transmitted to said image displaying apparatus via said information transmission facility for each line to be transmitted, for each group including n-pieces of lines or for each frame, and said image displaying apparatus is capable of recognizing whether in a progressive scanning state or in an interlacing scanning state; and data of which a line is transmitted in a case of said interlacing scanning state.

4. The image data displaying system according to any one of claim 1, wherein said image displaying apparatus includes a line buffer of (n−1) pieces of lines and a controlling section, and when a time necessary for transmitting a line is set to i, a position of a line to be displayed is delayed by i×(n−1) at least and displayed from a position of said compressed image data via said information transmission facility.

5. The image data displaying system according to claim 1, wherein when said interlacing scanning state exists in a screen and it is assumed that said image data transmitted during said interlacing scanning state is an 1-th line among said n-pieces of lines, where said 1 is a natural number of 0 (zero) or more and (n−1) or less, data of said 1-th line is displayed for all lines of a group including n-pieces of lines in which said interlacing scanning is executed in said frame.

6. The image data displaying system according to claim 1, wherein said image displaying apparatus uses a storage-type display, and when said interlacing scanning state exists in a screen and it is assumed that said image data transmitted during said interlacing scanning state is an 1-th line among said n-pieces of lines, where said 1 is a natural number of 0 or more and (n−1) or less, only said 1-th line is scanned among a group including n-pieces of lines and other lines except for said 1-th line are not scanned and said image data which is previously written is displayed as it is.

7. The image data displaying system according to claim 6, wherein when said image displaying apparatus uses a device requiring an alternating voltage drive as said image display apparatus, a period continuing said interlacing scanning is set to 2n-pieces of frames in groups of n-pieces of lines, and thereby no remaining DC occurs.

8. The image data displaying system according to claim 1, wherein said image displaying apparatus includes a controlling section for controlling a display image based on an identifier added to each line forming an image.

9. The image data displaying system according to claim 1, wherein in said image displaying apparatus, an identifier is added to each said group of n-pieces of said lines to be a unit for said interlacing scanning, an operation state is recognized and a number of frames is counted.

10. An image data displaying system comprising:
an image drawing apparatus, and an image displaying apparatus;
said image drawing apparatus comprising:
a converting section for receiving electronic image data to be displayed and for converting said electronic image data into image data of a bit string;
a compressing section for compressing said image data into groups of plural lines such as n-pieces of lines of said image data which is compressed; and
a drawing controlling section, when a compressed result is below a predetermined rate of a data amount before compression, for outputting compressed image data as display data and for applying an identifier indicating said compressed image data to said display data, and when said compressed result is not below said predetermined rate of said data amount before compression, for selecting data of one line among n-pieces of lines, for outputting said data as display data and for applying an identifier indicating that a display block shifts to a partial interlacing drive and said display data is original data before compression or is data after compression to said display data to be output;
said image displaying apparatus comprising:
an image displaying section;
a decompressing section for receiving said display data transmitted from said image drawing apparatus via a communication transmission facility and for decompressing said display data so as to output a decompressed result; and
a display controlling section for analyzing said display data, when said display data has said identifier showing compressed image data, for outputting decompressed display data of n-pieces of lines which is an output from said decompressing section to said image displaying section, when said display data has said identifier indicating that said display data is a part of said partial interlacing drive, for receiving said display data of one line supplied from said decompressing section and for displaying said display data on said image displaying section, and when said image displaying section executes display, for preventing an average luminance from decreasing by drawing all n-pieces of lines using data of one line among n-pieces of lines as image data for said interlacing drive in order to eliminate a luminance difference between a part displayed by a progressive drive and a part displayed by said partial interlacing drive.

11. The image data displaying system according to claim 10, wherein said image displaying apparatus includes a line buffer for holding image data decompressed by said decompressing section, in a case of said progressive drive, said image data is supplied to said image displaying section and displayed after a time delay of (n−1) pieces of lines, in a case of said partial interlacing drive, data of one line of compressed image data to be transmitted to said decompressing section is transmitted using a time requiring to transmit image data compressed for said progressive drive of n-pieces of lines, image data is transmitted from said line buffer to said image displaying section at a timing at which said one line is originally displayed.

12. The image data displaying system according to claim 10, wherein said image displaying apparatus includes a state storing section for storing whether a drive state of a line to be displayed on said image displaying section is said progressive drive or said partial interlacing drive.

13. An image drawing apparatus comprising:
a converting section for receiving electronic image data to be displayed and for converting said electronic image data into an image data of a bit string form;
a compressing section for compressing said image data in groups of plural lines such as n-pieces of lines of said image data which is converted; and
a drawing controlling section, when a compressed result is below a predetermined rate of a data amount before compression, for outputting compressed image data as display data to an image drawing apparatus and for applying an identifier indicating said compressed image data to said display data, and when said compressed result is not below said predetermined rate of said data amount before compression, for selecting data of one line among n-pieces of lines, for outputting said data as display data to said image drawing apparatus and applying an identifier indicating that a display block shifts to a partial interlacing drive and said display data is original data before compression or is data after compression to said display data to be output.

14. An image displaying apparatus comprising:
a decompressing section for receiving display data which is compressed into groups of plural lines such as n-pieces, when a compressed result is below a predetermined rate of a data amount before compression, for applying an identifier indicating said compressed image data to said display data, and when said compressed result is not below said predetermined rate of said data amount before compression, for selecting data of one line among n-pieces of lines, for outputting said data as display data and for applying an identifier indicating that a display block shifts to a partial interlacing drive and said display data is original data before compression or is data after compression, to said display data, and for decompressing said display data and outputting a decompressed result; and
a display controlling section for analyzing said display data, when said display data has said identifier showing compressed data, for outputting decompressed display data of n-pieces of lines which is an output from a decompressing section to an image displaying section, when said display data has said identifier showing that said display data is a part of said partial interlacing drive, for receiving display data of one line supplied from said decompressing section and displaying said display data on said image displaying section, and when said image displaying section executes display, for preventing average luminance from decreasing by drawing all n-pieces of lines using data of one line among n-pieces of lines as image data for said partial interlacing drive in order to eliminate a luminance difference between a part displayed by a progressive drive and a part displayed by said partial interlacing drive.

15. The image displaying apparatus according to claim 14, further comprising:
a line buffer for holding image data decompressed by said decompressing section:
wherein in a case of said progressive drive, said image data is supplied to said image displaying section and displayed after a time delay of (n−1) pieces of lines, in a case of said partial interlacing drive, data of one line of compressed image data to be transmitted to said decompressing section is transmitted using a time requiring to transmit image data compressed for said progressive drive of n-pieces of lines, image data is transmitted from said line buffer to said image displaying section at a timing at which said one line is originally displayed.

16. The image displaying apparatus according to claim 14, further comprising:
a state storing section for storing whether a drive state of a line to be displayed on said image displaying section is said progressive drive or said partial interlacing drive.

17. The image displaying apparatus according to claim 14, wherein in a case of interlacing scanning to said image displaying section, a line buffer of (n−1) pieces of lines corresponding to a number n of lines in a group is provided in order to eliminate a display delay by delaying a time in said image displaying section by a time for displaying (n−1) pieces of lines and concerning a block which shifts to an interlacing scanning state once, interlacing scanning is executed continuously during 2n-pieces of frames corresponding to said number n of lines in said group at least in order to set an average voltage in pixel portions in said image displaying section to zero.

18. An image drawing method comprising:
a step of receiving electronic image data to be displayed and of converting said electronic image data into image data of a bit string form;
a step of compressing said image data into groups of plural lines such as n-pieces of lines of said image data which is converted; and
a step, when a compressed result is below a predetermined rate of a data amount before compression, for outputting compressed image data as display data to an image drawing apparatus and for applying an identifier indicating said compressed image data to said display data, and when said compressed result is not below said predetermined rate of said data amount before compression, of selecting data of one line among n-pieces of lines, of outputting said data as display data to said image drawing apparatus and of applying an identifier indicating that a display block shifts to a partial interlacing drive and said display data is original data before compression or is data after compression to said display data to be output.

19. An image drawing program for causing a computer to carry out an image drawing method, said image drawing method comprising:
a step of receiving electronic image data to be displayed and of converting said electronic image data into image data of a bit string form;
a step of compressing said image data into groups of plural lines such as n-pieces of lines of said image data which is converted; and
a step, when a compressed result is below a predetermined rate of a data amount before compression, of outputting compressed image data as display data to an image drawing apparatus and of applying an identifier indicating said compressed image data to said display data, and when said compressed result is not below said predetermined rate of said data amount before compression, of selecting data of one line among n-pieces of lines, of outputting said data as display data to said image drawing apparatus and of applying an identifier indicating that a display block shifts to a partial interlacing drive and said display data is original data before compression or is data after compression to said display data to be output.
